(19) United States
(12) Patent Application Publication
(10) Pub. No.: US 2008/0216003 A1
(43) Pub. Date: Sep. 4, 2008

(54) Rack management system and display apparatus and control apparatus for use in rack management system

(75) Inventor: Hideki Onishi, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 11/905,609

(22) Filed: Oct. 2, 2007

(30) Foreign Application Priority Data
Mar. 1, 2007 (JP) 2007-051689

(51) Int. Cl. G06F 3/048

(52) U.S. Cl. 715/764

(57) ABSTRACT

A rack management system for managing the mounting conditions of information processing apparatuses mounted in racks in a rack cabinet comprises: a display apparatus, provided for each of the information processing apparatuses, for displaying in an alterable method identification information for identifying the information processing apparatus mounted in a corresponding one of the racks in the rack cabinet and a control apparatus for controlling the identification information to be displayed on the display apparatus.

### BACKGROUND OF THE INVENTION

1. Field of the Invention

The present invention relates to a rack management system for managing the mounting conditions of an information processing apparatus mounted in racks in a rack cabinet, and a display and control apparatus for use in the rack management system.

2. Description of the Related Art

In recent years, information processing apparatuses such as servers are densely mounted to save space. For example, it is known to provide a rack mount system for housing multiple information processing apparatuses by mounting them in racks one on top of another in a rack cabinet. FIG. 18 is an external view showing a typical rack mount system 100.

A rack mount system designed with multiple functions, such as space saving, power saving, high heat dissipation, and high security functions, is also proposed, as disclosed, for example, in Japanese Unexamined Patent Publication No. 2000-334059.

A similar multi-functional rack mount system is also disclosed, for example, in Japanese Unexamined Patent Publication No. 2003-174273, which uses a camera for the management of mounted servers.

While such prior art multi-functional rack mount systems have been able to achieve a certain degree of effect in terms of space saving, power saving, high heat dissipation, and high security, no particular effect has been obtained in terms of design management as to which server has been mounted in which rack in the rack cabinet or in terms of operation management as to which port of the power distribution unit (PDU) the server mounted in each individual rack is connected to.

For example, for a designer who has designed the system for the rack cabinet, no particular problem arises in terms of the design or operational management, but for other people, there has been a problem that it is difficult to understand the details of the system construction, because of complicated wiring, multiple layered racks, restricted mounting space, etc., and it is therefore not possible to easily understand the how the individual servers are mounted. In particular, this problem is compounded when a design change is made after the construction of the system.

In view of the above problem, it is an object of the present invention to provide a rack management system that can be easily managed and understood with regard to the information processing apparatuses mounted in racks in a rack cabinet, and a display and control apparatus for use in the rack management system.

### SUMMARY OF THE INVENTION

To achieve the above object, according to the present invention, a rack management system for managing the mounting conditions of information processing apparatuses mounted in racks in a rack cabinet comprises: a display apparatus, provided for each of the information processing apparatuses, for displaying in an alterable manner identification information for identifying the information processing apparatuses mounted in one of the racks in the rack cabinet; and a control apparatus for controlling the identification information to be displayed on the display apparatuses.

The rack management system further comprises: image capturing means for capturing an image of the identification information displayed on the display apparatuses; and on-screen display means for displaying the image captured by the image capturing means on a display monitor screen by using an OSD function.

In an alternative mode, the rack management system further comprises: image capturing means for capturing an image of the identification information displayed on the display apparatuses; a memory which stores a control program for displaying the image captured by the image capturing means on a display monitor screen; and processing means for executing the control program.

In this way, in the present invention, the display apparatus is mounted near each rack in the rack cabinet, and displays information concerning the mounting condition of the information processing apparatus mounted in the rack. On the other hand, the control apparatus controls the contents to be displayed on the display apparatus that is mounted near each rack in the rack cabinet and that displays information concerning the mounting condition of the information processing apparatus mounted in the rack.

### BRIEF DESCRIPTION OF THE DRAWINGS

The present invention will be more clearly understood from the description as set forth below with reference to the accompanying drawings, wherein:

FIG. 1 is a front view of a rack management system according to an embodiment of the present invention;

FIG. 2 is a rear view of the rack management system according to the embodiment of the present invention;

FIG. 3 is an external view showing display apparatus according to the embodiment of the present invention;

FIG. 4 is a front view showing mounting means for mounting the display apparatus according to the embodiment of the present invention;

FIG. 5 is a rear view showing the mounting means for mounting the display apparatus according to the embodiment of the present invention;

FIG. 6 is a diagram showing a cable take-up mechanism;

FIG. 7 is a block diagram of the rack management system according to the embodiment of the present invention;

FIG. 8 is a diagram showing one example of the image captured by an image capturing means in the rack management system according to the embodiment of the present invention;

FIG. 9 is a block diagram of a control apparatus in the rack management system according to a modified example of the embodiment of the present invention;

FIG. 10 is an external view of a display apparatus in the rack management system according to the modified example of the embodiment of the present invention;

FIG. 11 is a system block diagram showing an example of the rack management system according to the embodiment of the present invention as incorporated in a rack cabinet;

FIG. 12 is a block diagram of a control apparatus in the rack management system according to a modified example of the embodiment of the present invention;

FIG. 13 is a block diagram showing a further modified example of the control apparatus shown in FIG. 12;

FIG. 14 is a block diagram of a control apparatus in the rack management system according to a modified example of the embodiment of the present invention;

FIG. 15 is a block diagram showing a further modified example of the control apparatus shown in FIG. 14;

FIG. 16 is a diagram showing one example of a server information acquiring method selection menu according to the embodiment of the present invention;

FIG. 17 is a block diagram showing a modified example of image processing in the rack management system according to the embodiment of the present invention; and

FIG. 18 is an external view showing a typical rack mount system.

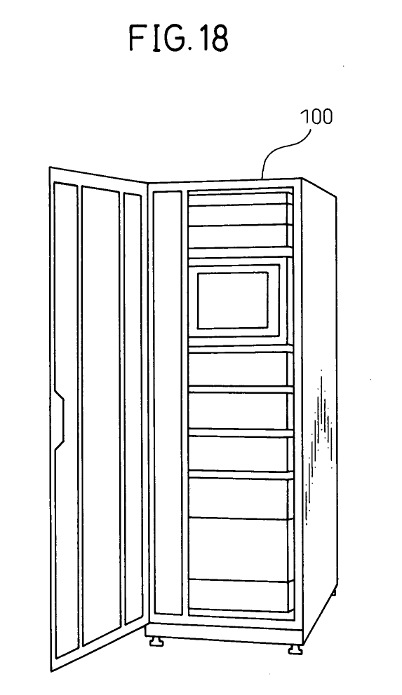

### DESCRIPTION OF THE PREFERRED EMBODIMENTS

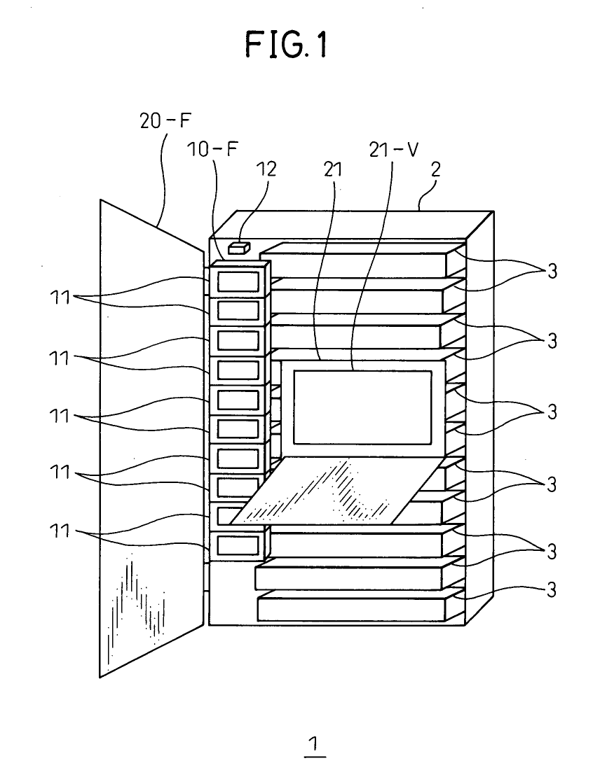

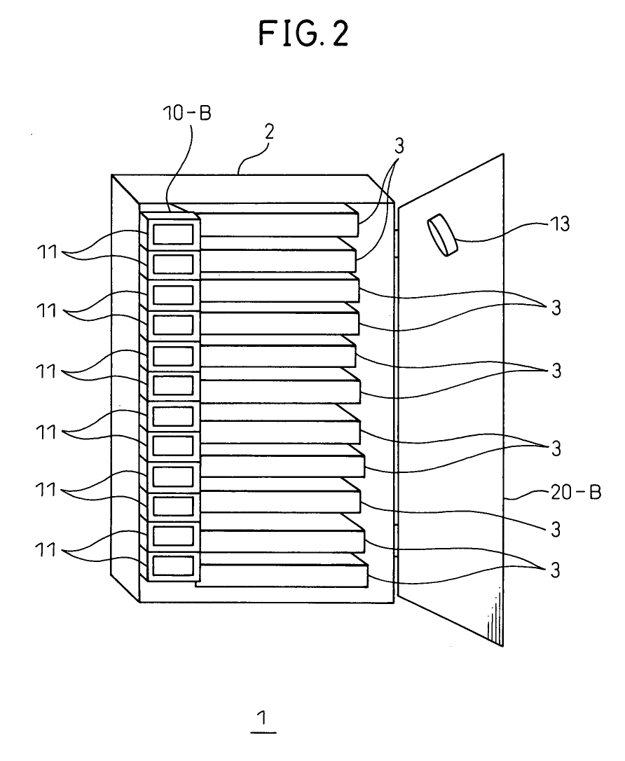

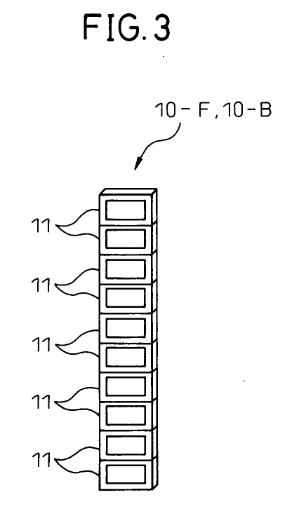

FIG. 1 is a front view of a rack management system according to an embodiment of the present invention, and FIG. 2 is a rear view of the rack management system according to the embodiment of the present invention. FIG. 3 is an external view showing a display apparatus according to the embodiment of the present invention. In the drawings given hereinafter, it is to be understood that component elements designated by the same reference numerals have the same functions.

The rack management system 1 for managing the mounting conditions of information processing apparatus 3 mounted in a rack in a rack cabinet 2 comprises: a display apparatus 11, provided for each information processing apparatus (server) 3, for displaying identification information for identifying the information processing apparatus (server) 3 mounted in one of the racks in the rack cabinet 2; and a control apparatus 12 for controlling the identification information to be displayed on the display apparatus 11.

In particular, as shown in FIG. 3, each display apparatus 11 is electrically connected to each other to form display apparatus arrays 10-F and 10-B. This electrical connection is made using a cable. A cable is also used to electrically connect the control apparatus 12 to one of the display apparatus 11. Various kinds of data are transferred via the cable, and, power is also supplied via the same cable to the display apparatus 11. As a modified example, the electrical connection may be made using a wireless communication means as will be described later.

To protect the servers 3 in the rack cabinet 2 from dust, a door 20-F is provided on the front of the rack cabinet 2, and a door 20-B on the back thereof. Further, a console drawer 21 comprising a display monitor 21-V and a keyboard and/or mouse is mounted on the front of the rack cabinet 2. For example, when performing maintenance of the servers, the doors 20 are opened, and the console drawer 21 is operated.

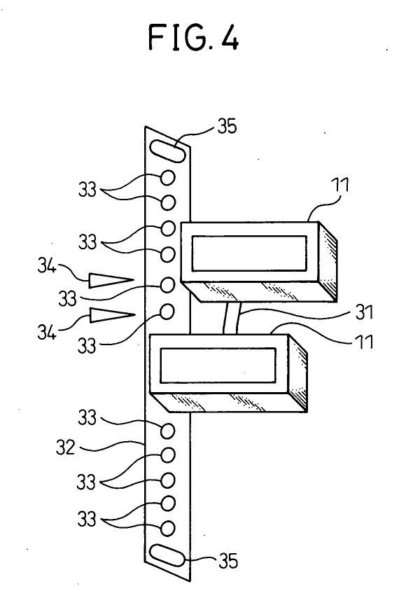

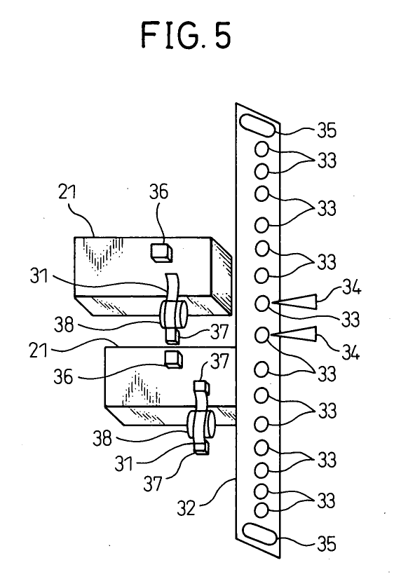

In the illustrated example, the display apparatus arrays 10 are mounted by using mounting means to the front and back of the rack cabinet 2 in which the information processing apparatus are mounted. The mounting means used here will be described later with reference to FIGS. 4 and 5.

Each display apparatus 11 in the display apparatus arrays 10 is mounted near one of the racks in the rack cabinet 2, and displays the information concerning the mounting condition of the information processing apparatus mounted in the corresponding rack. More specifically, the display apparatus 11 displays, for example, the name and identification information of the information processing apparatus, or the name of the connection port of the power distribution unit (PDU) located on the back side of the rack cabinet 2. According to the present invention, therefore, even people other than the designer who constructed the system for the rack cabinet can easily check which server (information processing apparatus) has been mounted in which rack in the rack cabinet, and to which port of the power distribution unit (PDU) the server mounted in each rack is connected. In this way, an improvement in design management can be achieved. How the contents displayed on the display apparatus 11 are altered will be described later.

In the present embodiment, each display apparatus 11 is constructed, for example, from a liquid crystal display, but other kinds of display apparatuses, such as a CRT, an organic EL display, or a plasma display, may be used. In the present embodiment, the height of each display apparatus 11 is about 3 cm to match the rack spacing, since the display apparatus 11 is installed near the rack in the rack cabinet 2 in which the corresponding information processing apparatus is mounted. However, the present invention is not limited to this particular height, but another height may be employed. Further, in the present invention, the width of each display apparatus 11 is about 5 cm, but the present invention is not limited to this particular width, and another width may be employed.

An image capturing means 13 is mounted on the back door 20-B of the rack cabinet 2. The image capturing means 13 captures an image of the contents, such as identification information displayed on the display apparatus 11, in the display apparatus array 10-B mounted on the back side of the rack cabinet 2. The image capturing means 13 may be constructed from a conventional camera or from an infrared camera, a CCD camera, or a camera equipped with a fisheye lens. The captured image may be a moving image or a still image. A separate image capturing means may be provided for capturing an image of the contents, such as identification information, displayed on the display apparatus in the display apparatus array 10-F mounted on the front side of the rack cabinet 2.

The image captured by the image capturing means 13 is displayed on the display monitor 21-V of the console drawer 21 mounted on the front of the rack cabinet 2. As a result, when checking the wiring on the back side of the rack cabinet 2, for example, the person who is checking does not need to move around to the back side as in the prior art, but can check the display produced on the display monitor 21-V of the console drawer 21 mounted on the front side of the rack cabinet 2. According to the present invention, any person can easily check the mounting condition of each server mounted in the rack cabinet 2 even when the wiring between the servers 3 is complicated or when the mounting space is tight. In this way, an improvement in operation management can be achieved. A specific method for displaying the captured image on the display monitor 21-V will be described in detail later.

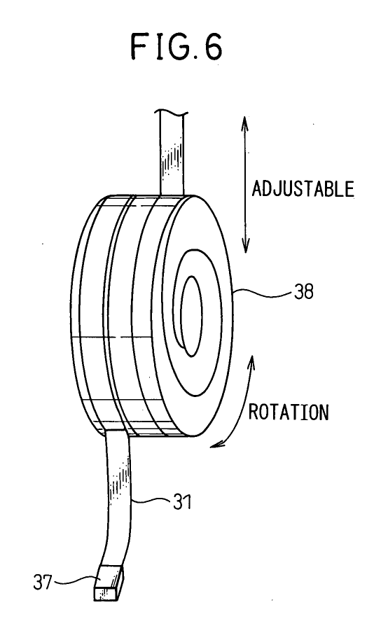

FIGS. 4 and 5 are diagrams showing the mounting means for mounting the display apparatus according to the embodiment of the present invention. FIG. 4 is a front view, and FIG. 5 is a rear view. FIG. 6 is a diagram showing a cable take-up mechanism. As described earlier, the display apparatus arrays 10 are mounted to the front and back of the rack cabinet 2 in which the information processing apparatus are mounted. Each information processing apparatus 11 is installed near the rack in which the corresponding server 3 is mounted. The mounting means for this purpose is constructed in the following manner.

A support plate 32 is provided with a plurality of threaded holes 33, and each display apparatus 11 is fixed to the threaded holes 33 with screws 34 by selecting the threaded holes 33 so that the display apparatus 11 is mounted in close proximity to the rack that holds the corresponding server 3. The support plate 32 is provided with rack mounting holes 35 in addition to the threaded holes 33, and the support plate 32 is attached to the rack cabinet 2 by means of the rack mounting holes 35.

Each display apparatus 11 is electrically connected to another display apparatus 11 in cascade, forming the display apparatus arrays 10-F and 10-B. This electrical connection is made using a cable 31. A connecting jack 36 is mounted on the back side of each display apparatus 11 opposite from the side thereof having a display screen. One end of the cable 31 is electrically and physically secured to the back side of the display apparatus 11. The other end of the cable 31 is provided with a connecting plug 37 which connects to the connecting jack 36 mounted on another display apparatus 11, and the two display apparatus 11 are electrically connected together. The control apparatus 12 is connected to one of the display apparatus 11 via a cable. The display apparatuses 11 are thus electrically connected in cascade, and the display apparatus 11 located at one end of the cascade is electrically connected to the control apparatus 12.

The distance from one display apparatus 11 to another is determined by which threaded holes 33 of the support plate 32 the respective display apparatus 11 are fixed to, but the length of the cable 11 is made adjustable by considering the ease of system construction, a possible future design change in server mounting position, etc. The cable take-up mechanism 38 is provided for this purpose. The cable take-up mechanism 38 has a cylindrically shaped double structure in which the cable 31 connected to a spring in each cylinder is wound around it by the force of the spring.

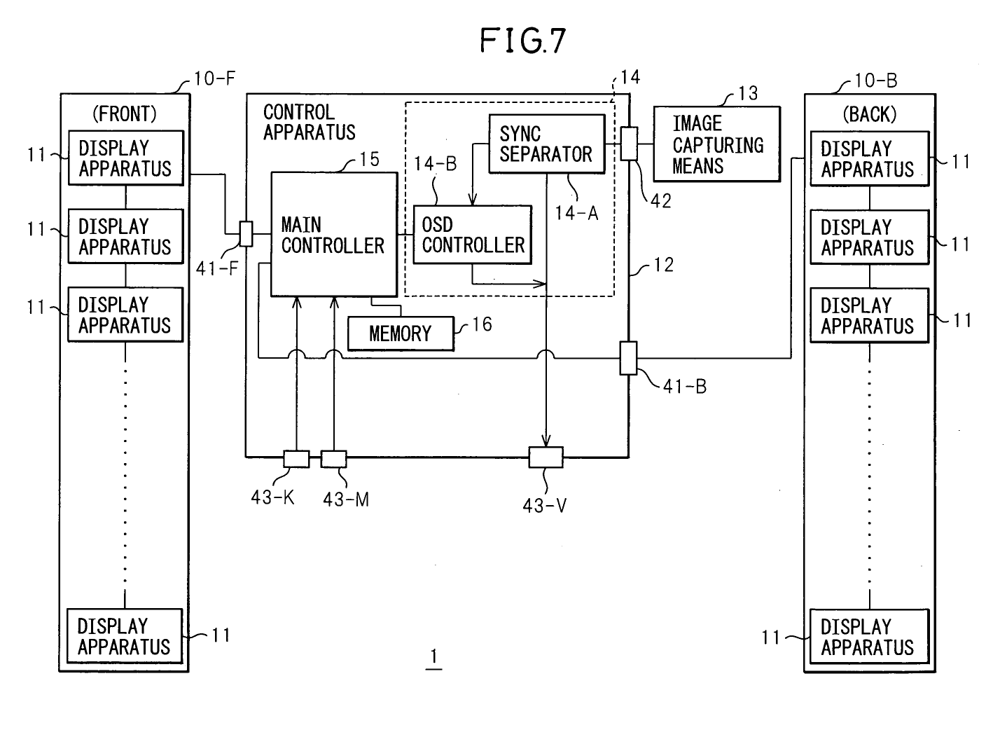

FIG. 7 is a block diagram of the rack management system according to the embodiment of the present invention. The control apparatus 12 in the rack management system 1 is provided with connectors 41-F and 41-B. The display apparatus array 10-F mounted on the front of the rack cabinet 2 is electrically connected to the display apparatus array connecting connector 41-F, while the display apparatus array 10-B mounted on the back of the rack cabinet 2 is electrically connected to the display apparatus array connecting connector 41-B. These electrical connections are made as earlier described.

The control apparatus 12 is also provided with an imaging capturing means connecting connector 42 for connecting the image capturing means 13. The control apparatus 12 is further provided with a keyboard connecting connector 43-K, a video output connector 43-V, and a mouse connecting connector 43-M to which the keyboard, display monitor, and mouse of the console drawer 21 (not shown in FIG. 7) are respectively connected. As will be described later, a KVM switch may be connected to the keyboard connecting connector 43-K, video output connector 43-V, and mouse connecting connector 43-M. The control apparatus 12 further includes an on-screen display means 14, a main controller 15, and a memory 16.

The on-screen display means 14 is a means for displaying the image captured by the image capturing means 13 on the display monitor screen by using an OSD function, and includes a sync separator 14-A and an OSD controller 14-B. The on-screen display means 14 can be implemented using a commercially available OSD chip.

The image capturing means 13 captures an image of the contents, such as identification information, displayed on the display apparatus 11 in the display apparatus array 10-B mounted on the back side of the rack cabinet 2. The video signal representing the captured image is transferred via the imaging capturing means connecting connector 42 to the sync separator 14-A in the on-screen display means 14. The sync separator 14-A separates horizontal (H) and vertical (V) sync signals. The separated horizontal (H) and vertical (V) sync signals are fed to the OSD controller 14-B. The video signal after separating the horizontal (H) and vertical (V) sync signals is directly coupled to the video output connector 43-V. This video signal is output, for example, to the display monitor of the console drawer 21 connected to the video output connector 43-V.

The role of the main controller 15 is to superimpose the display produced by the OSD onto the output of the video signal, thereby prompting the operator to enter from the keyboard the contents desired to display on the designated display apparatus in the display apparatus array, and transmit the thus entered display contents to the designated display apparatus in the display apparatus array. When the operator desires to produce some kind of display on the display apparatus 11 corresponding to the designated information processing apparatus, the operator performs a prescribed hot key operation on the keyboard to invoke the OSD function.

The main controller 15 receives the keyboard entered signal via the keyboard connecting connector 43-K. The main controller 15 checks the received signal to see whether it is a hot key for the OSD function. If it is a hot key for the OSD function, the main controller 15 sends an OSD command to the OSD controller 14-B, which in response to the command, produces the display in synchronism with the acquired horizontal (H) and vertical (V) sync signals. The display produced here may be, for example, a message prompting the operator to select the display apparatus whose display contents he desires to edit, and this message is displayed on the display monitor by the on-screen display means 14 using the OSD function. Then, using the keyboard, the operator enters the identification information for designating the desired display apparatus, and also enters the character string he desires to display on the display apparatus. For example, the character string “Windows (registered trademark) 2000 server” is displayed on the display apparatus numbered “1”. The main controller 15 sends the data concerning the thus entered display contents to the designated display apparatus in the display apparatus array. The data here comprises address information for the operator-designated display apparatus and data concerning the display contents the operator desires to display on the display apparatus. The data is sent to the display apparatus arrays 10-F and 10-B via the display apparatus array connecting connectors 41-F and 41-B, respectively. Each display apparatus 11 is constantly monitoring the address information contained in the received data, and receives the data concerning the display contents if the address information contained in the received data matches its own address information. The display apparatus 11 then displays the received contents on the display. Since the operator can thus alter (edit) the contents displayed on the display apparatus corresponding to the designated information processing apparatus, the operator can visually easily name the information processing apparatus. According to the present invention, the mounting condition of each server can be easily managed, even when a design change is made after the construction of the system.

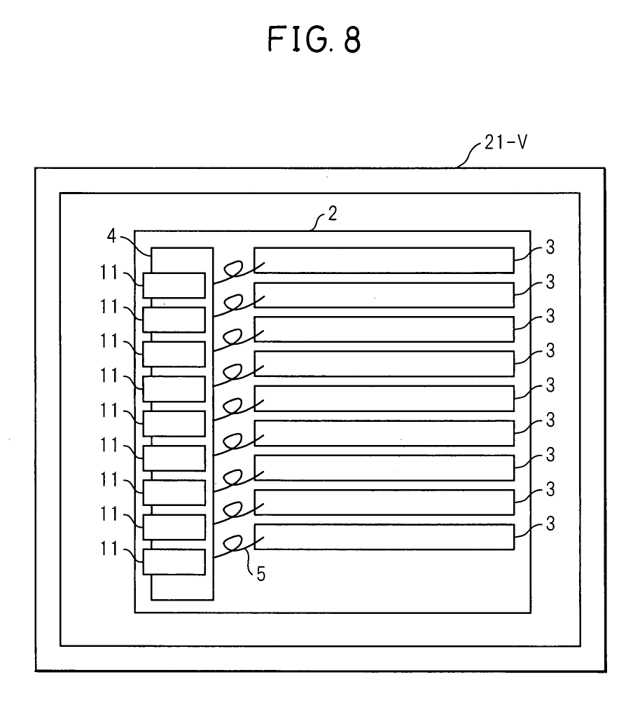

FIG. 8 is a diagram showing one example of the image captured by the image capturing means in the rack management system according to the embodiment of the present invention. As earlier described, in the present embodiment, the image capturing means 13 captures the image of the contents, such as identification information, displayed on the display apparatus 11 in the display apparatus array 10-B mounted on the back side of the rack cabinet 2. When the video signal representing the captured image is output to the display monitor 21-V of the console drawer 21 connected to the video output connector 43-V, the image such as illustrated in FIG. 8 is displayed. The display monitor 21-V displays the identification number of each server 3 displayed on the corresponding display apparatus 1, thus showing to which port of the power distribution unit (PDU) 4 the server 3 mounted in each rack is connected via a power supply cable 5 on the back side of the rack cabinet 2. This facilitates the operation management which manages as to which port of the power distribution unit (PDU) 4 the server 3 mounted in each rack is connected to.

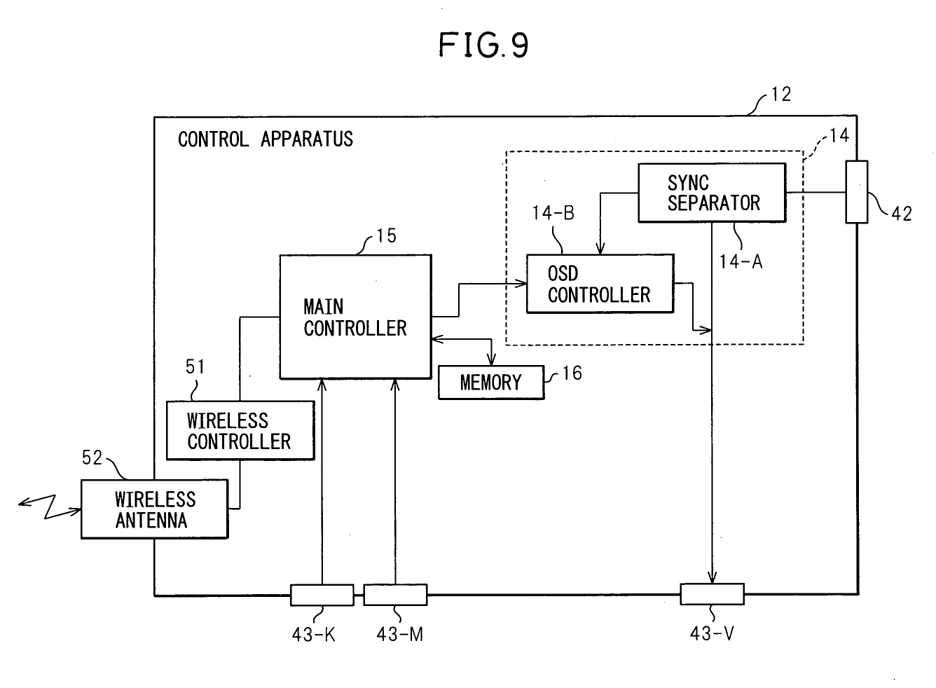

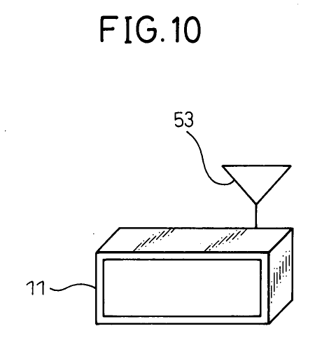

In the above embodiment, each display apparatus 11 is electrically connected to the control apparatus 12 via the cable 31, but as a modified example, the electrical connection may be made using a wireless communication means. FIG. 9 is a block diagram of a control apparatus in the rack management system according to such a modified example of the embodiment of the present invention. FIG. 10 is an external view of a display apparatus in the rack management system according to the modified example of the embodiment of the present invention. In this modified example, as shown in FIG. 9, the control apparatus 12 is provided with a wireless controller 51 and a wireless antenna 52 for wireless communications between the control apparatus 12 and the display apparatus 11. The other circuit elements are the same as those shown in FIG. 7, therefore, the same circuit elements are designated by the same reference numerals, and the details of such circuit elements will not be described here.

The wireless controller 51 shown in FIG. 9 wirelessly transmits a command for directing the altering of the display contents of information concerning the mounting condition of the information processing apparatus to be displayed on the display apparatus 11, together with information concerning the new mounting condition of the information processing apparatus, to the display apparatus 11 via the wireless antenna 52. The wireless signal here is transmitted to all the display apparatus 11 in parallel. Accordingly, the wireless signal carries address information for the operator-designated display apparatus and data concerning the display contents the operator desires to display on the display apparatus.

In this modified example, as shown in FIG. 10, the display apparatus 11 is also provided with a wireless antenna 53 and a wireless controller (not shown) for wireless communications between the control apparatus 12 and the display apparatus 11. The display apparatus 11 shown in FIG. 10 receives via the wireless antenna 53 the command for directing the altering of the display contents of the information concerning the mounting condition of the information processing apparatus mounted in each rack in the rack cabinet, together with the information concerning the new mounting condition of the information processing apparatus. Each display apparatus 11 is constantly monitoring the address information contained in the data received via the wireless antenna 53, and receives the data concerning the display contents if the address information contained in the received data matches its own address information. The display apparatus 11 then displays the received contents on the display. In this modified example, power for operating the display apparatus 11 is supplied from an internal power supply such as a suitable battery or solar cell.

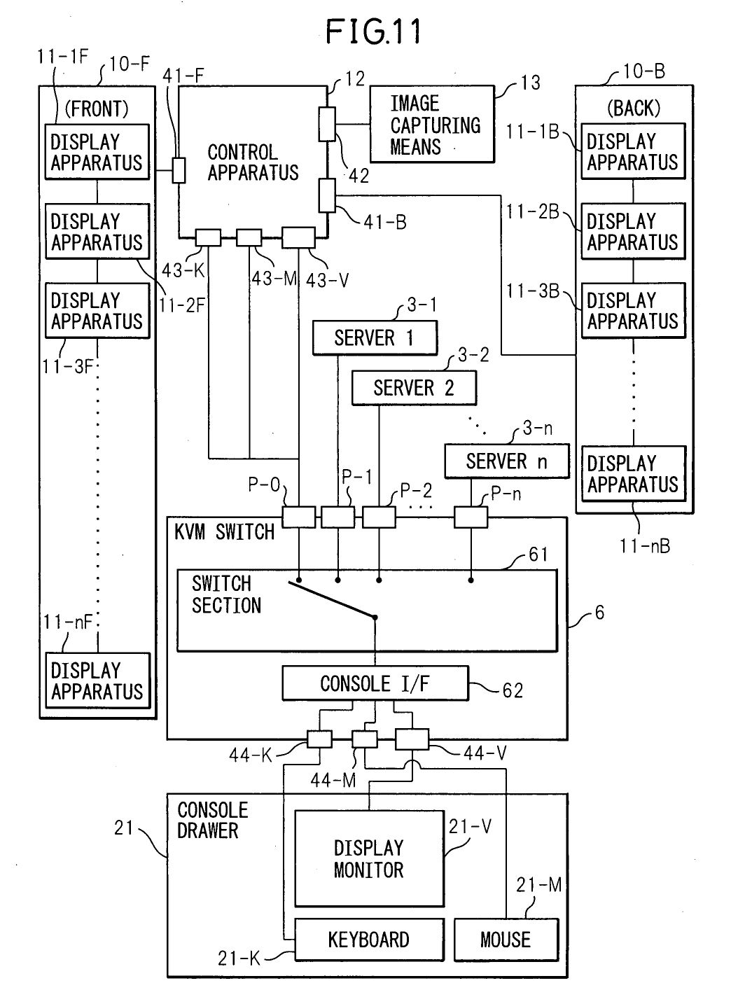

FIG. 11 is a system block diagram showing an example of the rack management system according to the embodiment of the present invention as incorporated in the rack cabinet. In the illustrated example, n servers 3-1, 3-2, . . . , 3-n (n is a positive integer; the same applies hereinafter) are mounted in the rack cabinet, and the display apparatus array 10-F comprising the display apparatus 11-1F, 11-2F, 11-3F, . . . , 11-nF and the display apparatus array 10-B comprising the display apparatus 11-1B, 11-2B, 11-3B, . . . , 11-nB are respectively mounted on the front and back of the rack cabinet to correspond with the respective servers. Otherwise, the configuration of the rack management system 1 is the same as that described with reference to FIG. 7.

The control apparatus 12, because of the provision of the keyboard connecting connector 43-K, video connecting connector 43-V, and mouse connecting connector 43-M, can be connected to a port of a commercially available KVM (K: Keyboard, V: Video, M: Mouse) switch 6. The KVM switch 6 is connected between the console drawer 21 and the servers 3-1, 3-2, . . . , 3-n, and is used to connect the console drawer 21 to a selected one of the servers 3-1, 3-2, . . . , 3-n for communication. The KVM switch 6 includes a switch section 61 for switching the electrical connection and a console interface (I/F) 62. Using the KVM switch 6, the user can select a desired server from among the servers 3-1, 3-2, . . . , 3-n for connection to the console drawer 21. In the illustrated example, the control apparatus 12 is connected to port P-0, and the servers 3-1, 3-2, . . . , 3-n are connected to ports P-1, P-2, . . . , P-n, respectively.

The keyboard 21-K, the display monitor 21-V, and the mouse 21-M of the console drawer 21 are connected to ports 44-K, 44-V, and 44-M, respectively, on the KVM switch 6. The console drawer 21 is operated, for example, when performing maintenance on the servers. When the operator selects the port P-0 of the KVM switch, for example, the image that the image capturing means 13 captured of the display apparatus array mounted on the back of the rack cabinet can be displayed on the display monitor 21-V.

Further, as previously described, when the operator desires to produce some kind of display on, or alter the displayed contents of, the display apparatus 11-1F, 11-2F, . . . , 11-nF, 11-1B, 11-2B, . . . , or 11-nB corresponding to the designated information processing apparatus, the operator performs a prescribed hot key operation on the keyboard 21-K. Then, using the keyboard, the operator enters the identification information (address information) for designating the desired display apparatus, and also enters the character string he desires to display on the display apparatus. For example, when the server 302 is a Windows (registered trademark) 2000 server, and when it is desired to display the character string “Windows (registered trademark) 2000 server” on the second display apparatus 11-2B mounted on the back of the rack cabinet for the server 3-2, then the operator enters from the keyboard 21-K the address information for designating the second display apparatus 11-2B mounted on the back of the rack cabinet and the character string “Windows (registered trademark) 2000 server.” “Windows (registered trademark) 2000 server” is thus displayed on the display apparatus 11-2B. When such editing work is finished, the operator can switch the KVM switch 6 to select an appropriate port to display the usual server screen on the display monitor 21-V of the console drawer 21.

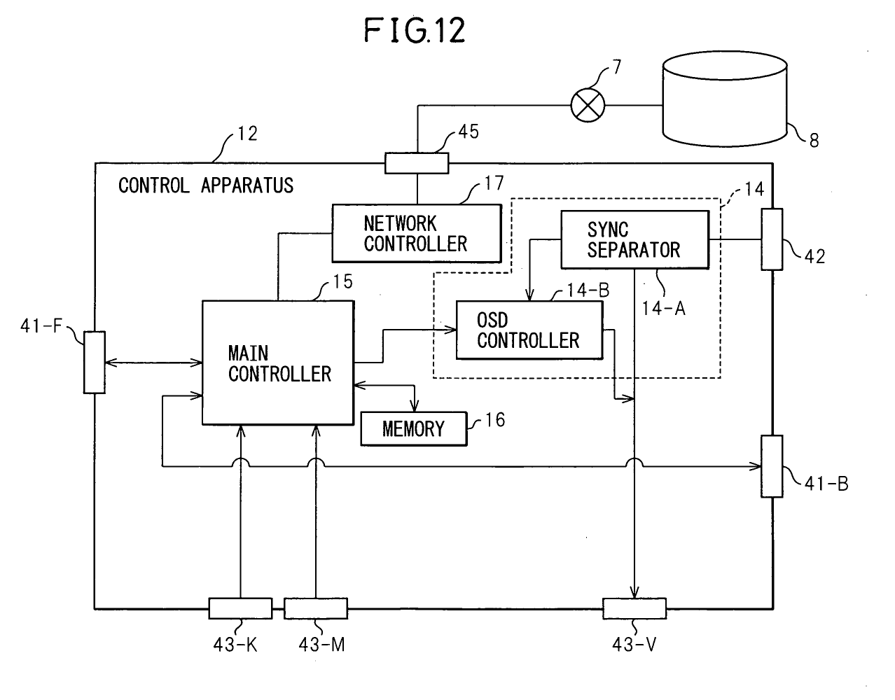

FIG. 12 is a block diagram of a control apparatus in the rack management system according to a modified example of the embodiment of the present invention. In this modified example, the control apparatus 12 has a network function, and the content to be displayed on the display apparatus is edited by acquiring information from a database 8 that manages server information. The control apparatus 12 includes a network controller 17 and a network connecting connector 45, and the database 8 is connected to the network connecting connector 45 via a network 7. The other circuit elements are the same as those shown in FIG. 7, therefore, the same circuit elements are designated by the same reference numerals, and the details of such circuit elements will not be described here.

Server information is stored in the database 8 shown in FIG. 12, and the main controller 15 in the control apparatus 12 issues a query to acquire data concerning the server information from the database 8. The main controller 15 sends the acquired data to the display apparatus connecting connectors 41-F and 41-B. The processing thereafter is the same as that described with reference to FIG. 7. In other words, each display apparatus is constantly monitoring the address information contained in the received data, and receives the data concerning the display contents (in this case, data concerning the server name) if the address information contained in the received data matches its own address information. The display apparatus then displays the received contents on the display. In this way, the operator can visually name the information processing apparatus easily by altering the contents displayed on the display apparatus corresponding to the designated information processing apparatus without entering characters from the keyboard.

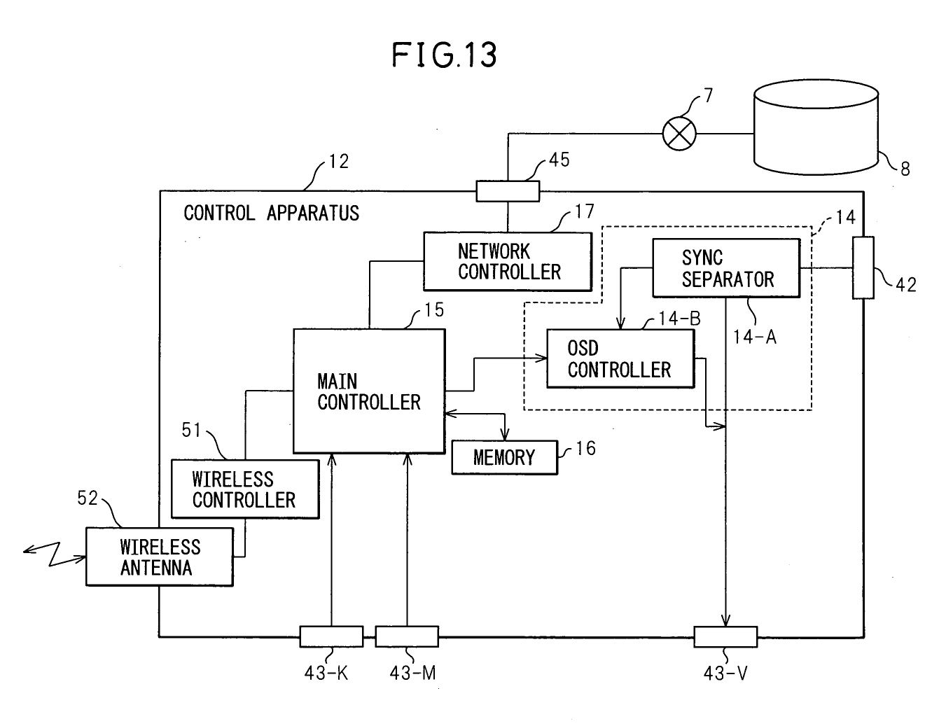

FIG. 13 is a block diagram showing a further modified example of the control apparatus shown in FIG. 12. In this modified example, the control apparatus 12 shown in FIG. 12 is further provided with a wireless controller 51 and a wireless antenna 52, such as described with reference to FIG. 9, for wireless communication between the control apparatus 12 and the display apparatus. The other circuit elements are the same as those shown in FIGS. 9 and 12, therefore, the same circuit elements are designated by the same reference numerals, and the details of such circuit elements will not be described here. The main controller 15 in the control apparatus 12 shown in FIG. 13 issues a query to acquire data concerning the server information from the database 8. The wireless controller 51 converts the server information transferred from the main controller 15 into a signal for output on a wireless link. The wireless antenna 52 transmits the wireless signal by radio waves to each display apparatus.

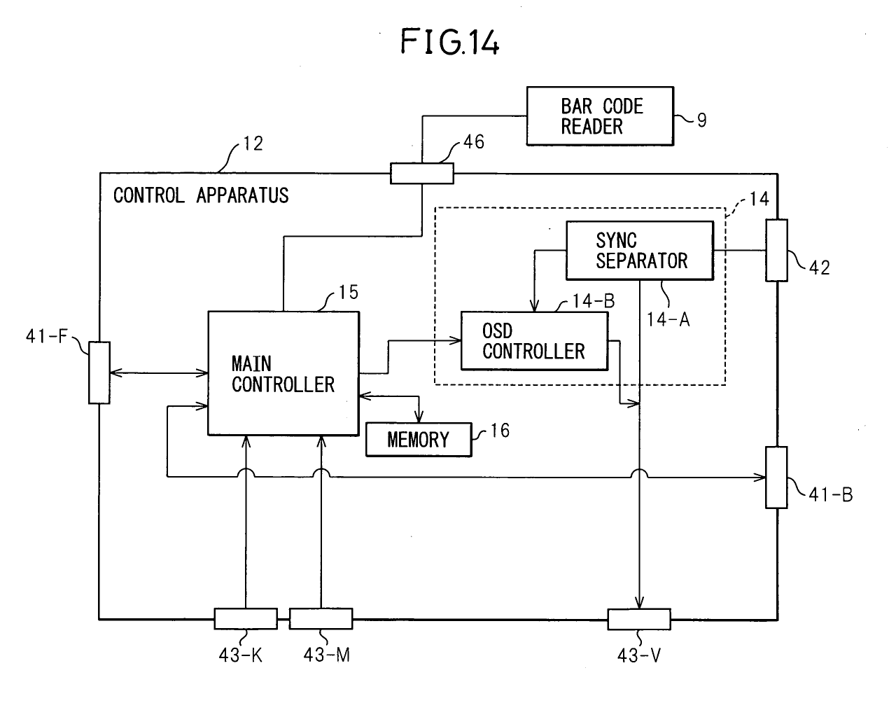

FIG. 14 is a block diagram of a control apparatus in the rack management system according to a modified example of the embodiment of the present invention. In this modified example, the server information (for example, sever name) is managed in the form of bar code, and the server information is read using a bar code reader 9. The contents displayed on the display apparatus is thus edited. The control apparatus 12 is provided with a serial communication connector 46, and the bar code reader 9 is connected to this serial communication connector 46. The other circuit elements are the same as those shown in FIG. 7, therefore, the same circuit elements are designated by the same reference numerals, and the details of such circuit elements will not be described here.

Names such as “Windows (registered trademark) 2000”, “Windows (registered trademark) 2000 server”, and “Windows (registered trademark) 2003 server” are bar-coded and prestored in a bar code table. The operator reads the bar code indicating the name of the designated information processing apparatus by using the bar code reader and thus acquires the data. The main controller 15 sends the acquired data to the display apparatus connecting connectors 41-F and 41-B. The processing thereafter is the same as that described with reference to FIG. 7. In other words, each display apparatus is constantly monitoring the address information contained in the received data, and receives the data concerning the display contents (in this case, data concerning the server name) if the address information contained in the received data matches its own address information. The display apparatus then displays the received contents on the display. In this way, the operator can visually name the information processing apparatus easily by altering the contents displayed on the display apparatus corresponding to the designated information processing apparatus without entering characters from the keyboard.

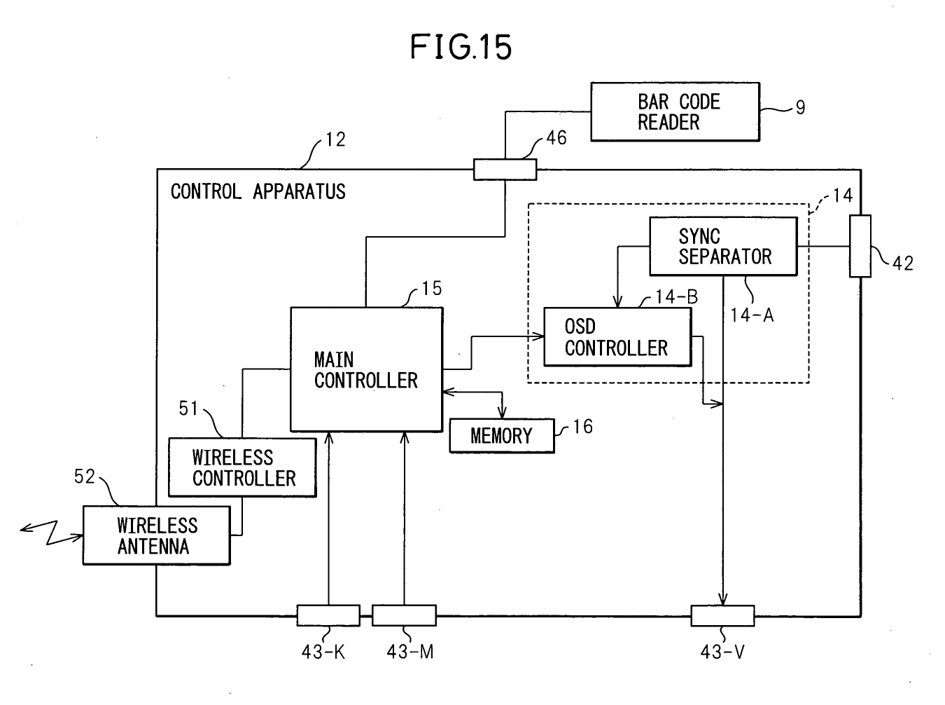

FIG. 15 is a block diagram showing a further modified example of the control apparatus shown in FIG. 14. In this modified example, the control apparatus 12 shown in FIG. 14 is further provided with a wireless controller 51 and a wireless antenna 52, such as described with reference to FIG. 9, for wireless communications between the control apparatus 12 and the display apparatus. The other circuit elements are the same as those shown in FIGS. 9 and 14, therefore, the same circuit elements are designated by the same reference numerals, and the details of such circuit elements will not be described here. The main controller 15 in the control apparatus 12 shown in FIG. 15 acquires the data read by the bar code reader 9. The wireless controller 51 converts the server information transferred from the main controller 15 into a signal for output on a wireless link. The wireless antenna 52 transmits the wireless signal by radio waves to each display apparatus.

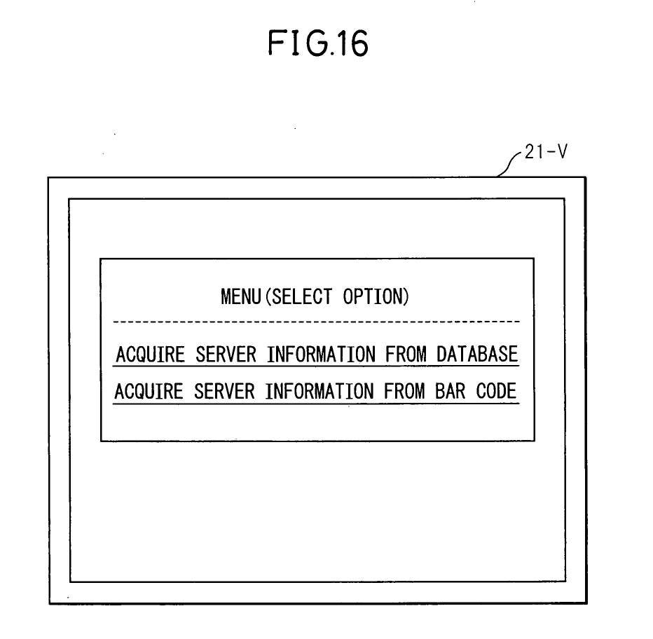

The method for acquiring the server information may be made selectable between the database method and the bar code method. FIG. 16 is a diagram showing one example of a server information acquiring method selection menu. For example, when a prescribed hot key operation is performed on the keyboard of the console drawer, the server information acquiring method selection menu is called on the display monitor 21-V of the console drawer. The selection menu provides two options, “ACQUIRE SERVER INFORMATION FROM DATABASE” and “ACQUIRE SERVER INFORMATION FROM BAR CODE”. The operator selects the desired option by using the mouse or the keyboard. Then, the earlier described processing is performed based on the thus selected server information acquiring method.

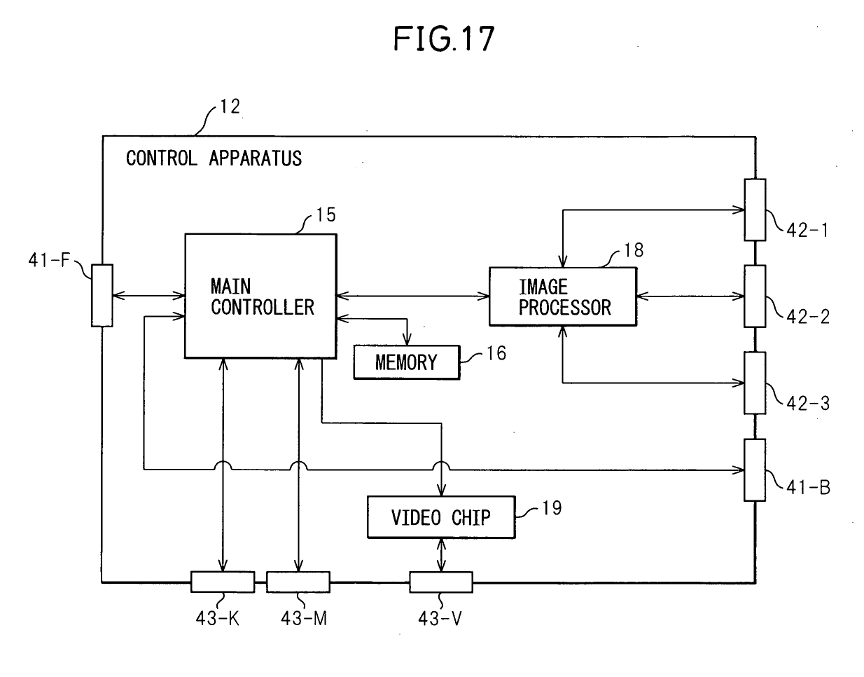

FIG. 17 is a block diagram showing a modified example of image processing in the rack management system according to the embodiment of the present invention. In this modified example, a plurality of image capturing means connecting connectors 42-1, 42-2, and 42-3 are provided in order to connect a plurality of image capturing means each for capturing the identification information displayed on each display apparatus. An image processor 18 converts an analog video signal received via each of the image capturing means connecting connectors 42-1, 42-2, and 42-3 into a digital signal, and transfers it to the main controller 15. A control program for displaying the image captured by each image capturing means on the display monitor screen is stored in the memory 16, the main controller 15 executes this control program, and using a video chip 19, displays the image captured by the image capturing means on the display monitor screen of the console drawer connected via the video connecting connector 43-V. The other circuit elements are the same as those shown in FIG. 7, therefore, the same circuit elements are designated by the same reference numerals, and the details of such circuit elements will not be described here.

The present invention can be applied to a rack management system for managing the mounting conditions of information processing apparatus such as servers mounted in racks in a rack cabinet.

According to the present invention, even persons other than the designer who constructed the system for the rack cabinet can easily check which server (information processing apparatus) has been mounted in which rack in the rack cabinet. They can also easily check to which port of the power distribution unit (PDU) the server mounted in each rack is connected.

For example, when checking the wiring on the back side of the rack cabinet, the person who is checking need not move around to the back side as in the prior art, but need only check the display produced on the display monitor of the console drawer mounted on the front side of the rack cabinet. Accordingly, any person can easily check the mounting condition of each server mounted in the rack cabinet even when the wiring between the servers is complicated or when the mounting space is tight.

Furthermore, according to the present invention, since the operator can alter (edit) the contents displayed on the display apparatus corresponding to the designated information processing apparatus, the operator can visually name the information processing apparatus easily. Accordingly, the mounting condition of each server can be easily managed, even when a design change is made after the construction of the system.

What is claimed is:

1. A rack management system for managing mounting conditions of information processing apparatus mounted in racks in a rack cabinet, comprising:
a display apparatus, provided for each of said information processing apparatus, for displaying in an alterable manner identification information for identifying said information processing apparatus mounted in a corresponding one of said racks in said rack cabinet; and
a control apparatus for controlling said identification information to be displayed on said display apparatus.

2. A rack management system as claimed in claim 1, further comprising mounting means for mounting said display apparatus near said rack in a corresponding relationship to said information processing apparatus mounted in said rack.

3. A rack management system as claimed in claim 2, wherein said mounting means is provided on a front side of the rack in which said information processing apparatus is mounted.

4. A rack management system as claimed in claim 2, wherein said mounting means is provided on a back side of the rack in which said information processing apparatus is mounted.

5. A rack management system as claimed in claim 1, further comprising wireless communication means for performing wireless communications between said control apparatus and said display apparatus.

6. A rack management system as claimed in claim 1, further comprising a cable for electrically connecting said control apparatus to one of said display apparatus and said one display apparatus to another one of said display apparatus in cascade.

7. A rack management system as claimed in claim 1, further comprising image capturing means for capturing an image of said identification information displayed on said display apparatus, and wherein
said control apparatus includes on-screen display means for displaying the image captured by said image capturing means on a display monitor screen by using an OSD.

8. A rack management system as claimed in claim 1, further comprising image capturing means for capturing an image of said identification information displayed on said display apparatus, and wherein
said control apparatus includes a memory which stores a control program for displaying the image captured by said image capturing means on a display monitor screen and processing means for executing said control program.

9. A display apparatus, mounted near each rack in a rack cabinet, for displaying in an alterable manner information concerning a mounting condition of an information processing apparatus mounted in said rack.

10. A display apparatus as claimed in claim 9, comprising receiving means for receiving a command for directing the altering of the information concerning the mounting condition of the information processing apparatus mounted in each rack, together with information concerning a new mounting condition of said information processing apparatus.

11. A display apparatus as claimed in claim 9, wherein said display apparatus is mounted on a front side of the rack in which said information processing apparatus is mounted.

12. A display apparatus as claimed in claim 9, wherein said display apparatus is mounted on a back side of the rack in which said information processing apparatus is mounted.

13. A control apparatus for controlling contents to be displayed on a display apparatus that is mounted near each rack in a rack cabinet and that displays in an alterable manner information concerning a mounting condition of an information processing apparatus mounted in said rack.

14. A control apparatus as claimed in claim 13, comprising transmitting means for transmitting a command for directing the altering of the contents of the information concerning the mounting condition of the information processing apparatus to be displayed on said display apparatus, together with information concerning a new mounting condition of said information processing apparatus, to said display apparatus.

15. A control apparatus as claimed in claim 13, comprising on-screen display means for displaying an image captured by an image capturing means, and representing the contents displayed on said display apparatus, on a display monitor screen by using an OSD.

16. A control apparatus as claimed in claim 13, comprising: a memory which stores a control program for displaying on a display monitor screen an image captured by an image capturing means and representing the contents displayed on said display apparatus and processing means for executing said control program.
